(19) United States
(12) Patent Application Publication
(10) Pub. No.: US 2003/0145230 A1
(43) Pub. Date: Jul. 31, 2003

(54) System for exchanging data utilizing remote direct memory access

(76) Inventors: Huimin Chiu, Los Altos, CA (US); Brent Callaghan, Mountain View, CA (US); Peter Staubach, Bromfield, CO (US); Theresa Lingutla-Raj, Saratoga, CA (US)

Correspondence Address: WAGNER, MURABITO & HAO LLP, Third Floor, Two North Market Street, San Jose, CA, 95113, US

(21) Appl. No.: 10/062,870

(22) Filed: Jan. 31, 2002

(51) Int. Cl. H04L 9/00

(52) U.S. Cl. 713/201

(57) ABSTRACT

Embodiments of the present invention are directed to a system for exchanging data utilizing Remote Direct Memory Access. In response to a system call, a Network File System component generates a file request. An External Data Representation component formats the file request and passes the request to a Remote Procedure Call component which initiates the file request with a remote computer system. The Remote Procedure Call is passed to a unifying layer which communicates the the Remote Procedure Call to various transport layer Remote Direct Memory Access implementations. The various Remote Direct Memory Access implementations are used to exchange the data in order to communicate the file request.

### FIELD OF THE INVENTION

Embodiments of the present invention relate to the field of distributed file access. More specifically, the present invention pertains to a network file system for exchanging data using Remote Direct Memory Access.

### BACKGROUND OF THE INVENTION

NFS is a widely implemented protocol and an implementation of a distributed file system which is designed to be portable across different computer systems, operating systems, network architectures, and transport protocols. NFS eliminates the need for duplicating common directories on every host in a network. Instead, a single copy of the directory is shared by the network hosts. To a network host using NFS, all of the file system entries are viewed the same way, whether they are local or remote. Additionally, because the NFS mounted file systems contain no information about the file server from which they are mounted, different operating systems with various file system structures appear to have the same structure to the hosts.

NFS is also built on the Remote Procedure Call (RPC) protocol which follows the normal client/server model. In the case of NFS, the resource is files and directories on the server that are shared by the clients in the network. The file systems on the server are mounted onto the clients using the standard Unix “mount” command, making the remote files and directories appear to be local to the client. However, existing NFS protocols, designed for local and wide area networks, no longer meet the high-bandwidth, low-latency file access requirements of the data center in-room networks.

FIG. 1 is a block diagram of an exemplary prior art network file system (NFS) file access protocol. An application 110 invokes a system call to Unix system call layer 120 to provide access to data it needs. Unix system call layer 120 provides a standard file system interface for applications to access data. The system call is forwarded to a Virtual File System (VFS) 130. VFS 130 allows a client to access many different types of file systems as if they were all attached locally. VFS 130 hides the differences in implementations under a consistent interface. If the requested data can be found locally, VFS 130 will direct the request to the local operating system, if the requested data is in a remotely located file, VFS 130 will direct the request to Network File System (NFS) 140.

NFS 140 provides a high-level network protocol and implementation for accessing remotely located files. The protocol provides the structure and language for file requests between clients and servers for searching, opening, reading, writing, and closing files and directories across a network. NFS 140 generates a file request and forwards the request to External Data Representation (XDR) layer 150.

XDR layer is a presentation layer standard which provides a common way of representing a set of data types over a network. It is widely used for transferring data between different computer architectures. XDR layer 150 formats the request and passes the request to Remote Procedure Call (RPC) layer 160. RPC provides a mechanism for one host to make a procedure call that appears to be part of the local process, but is really executed remotely on another computer on the network. In accordance with the formatting instructions provided by XDR layer 150, RPC layer 160 bundles the data passed to it, creates a session with the appropriate server, and sends the data to the server that can execute the RPC.

Depending on the type of connection established with server 190, the Remote Procedure Call utilizes either User Datagram Protocol (UDP) 170 or Transmission Control Protocol (TCP) 175 as a transport layer protocol. The call is then passed to Internet Protocol (IP) layer 180 and sent to server 185 over networking media.

In another implementation, the separation of the XDR and RPC layers is not as well defined and calls are passed between the XDR/RPC layer and the NFS layer. For example,NFS layer 140 makes a call to XDR/RPC layer to invoke a Remote Procedure Call. The RPC implementation calls into the XDR implementation in order to encode the arguments and responses for the Remote Procedure Call. XDR implementation calls into NFS layer 140 for information required to encode the specific NFS call being performed. NFS layer 140 returns a response to the XDR call which in turn returns a response to the RPC implementation. The Remote Procedure Call is then passed to the Transport layer protocols and sent to server 190.

A shortcoming of this model is that processing overhead in end stations can consume substantial resources to which the application should have access. More specifically, CPU utilization and memory bandwidth are becoming bottlenecks in implementing the high-bandwidth, low-latency file access requirements of the data center in-room networks.

Recent advances in the interconnect I/O technology, such as Virtual Interface (VI) and lnfiniBand (IB), have significantly improved host to host communications. They deliver high performance data access for Web, application, database, and Networked Attached Storage (NAS) servers and are getting widely deployed in the data centers. Both VI and IB support RDMA (Remote Direct Memory Access), a key hardware feature which facilitates remote data transfer to and from memory directly without intervention of CPUs. The RDMA model treats the network interface as being simply another DMA node. Benefits of using RDMA include fewer data copies, reduced CPU overhead, and far less network protocol processing.

FIG. 2 illustrates a Direct Access File System which utilizes Remote Direct Memory Access. In FIG. 2, an application 210 utilizes Direct Access File System (DAFS) 220 to request data from server 240 utilizing RDMA 230 to facilitate data transfer. DAFS 220 is a file access protocol which utilizes entirely different non-standard protocols than NFS. It also requires changes to input/output paths to create an interface between application 210 and DAFS 220. This can be a burden for network administrators who want to implement high speed data access which is compatible with existing software applications.

### SUMMARY OF THE INVENTION

Therefore, a need exists for a distributed file access system which can utilize high speed file access connections such as Remote Direct Memory Access. While meeting the above stated need, it would be advantageous to provide a system which supports various existing RDMA implementations as well as potential future implementations. Furthermore, while meeting the above stated needs, it would be advantageous to provide a system which is compatible with existing software applications.

Embodiments of the present invention provide a high speed file access technology, NFS over RDMA, which meet the requirements of the data center in-room networks by taking advantage of the RDMA-capable interconnects. The present invention adds a generic RDMA transport to the kernel RPC layer to support high speed RDMA-based interconnects and bypasses the TCP/IP stack during data transfer. The present invention provides high performance NFS with significant throughput improvement and reduce CPU overhead (e.g., fewer data copies, etc.) over the existing transports.

The RDMA transport can support multiple underlying RDMA-based interconnects and provide access to their RDMA services through a common API. Applications using this API are not required to be aware of the specifics of the underlying RDMA interconnects. Existing RPC transports continue to work as before. The RDMA transport is flexible and generic enough to allow for easy plug-ins of future RDMA interconnects. Because the present invention requires no changes to existing NFS and RPC protocols, no changes to applications running on NFS or existing NFS administration are required. For example, the existing NFS mount and automounter will not change.

The present invention utilizes a novel RPC RDMA transport as a generic framework, henceforth referred to as the RDMA Transport Framework (RDMATF), to allow for various RDMA-capable interconnect plug-ins. Candidate interconnect plug-ins currently under consideration are VI and IB. The RDMATF defines a new generic kernel RPC API that offers high speed RPC data transfer to applications while utilizing multiple underlying high speed RDMA-based interconnects. This API normalizes accesses to different RDMA-based interconnects so that applications using the RDMATF need not be aware of the underlying RDMA interconnects. It allows NFS to create client and server handles over RDMA and to transfer RPC messages using the RDMA Read and Write operations.

These and other advantages of the present invention will become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 is a block diagram of an exemplary prior art Network File System (NFS) file access implementation.

FIG. 2 is a block diagram of an exemplary prior art Direct Access File System file access implementation.

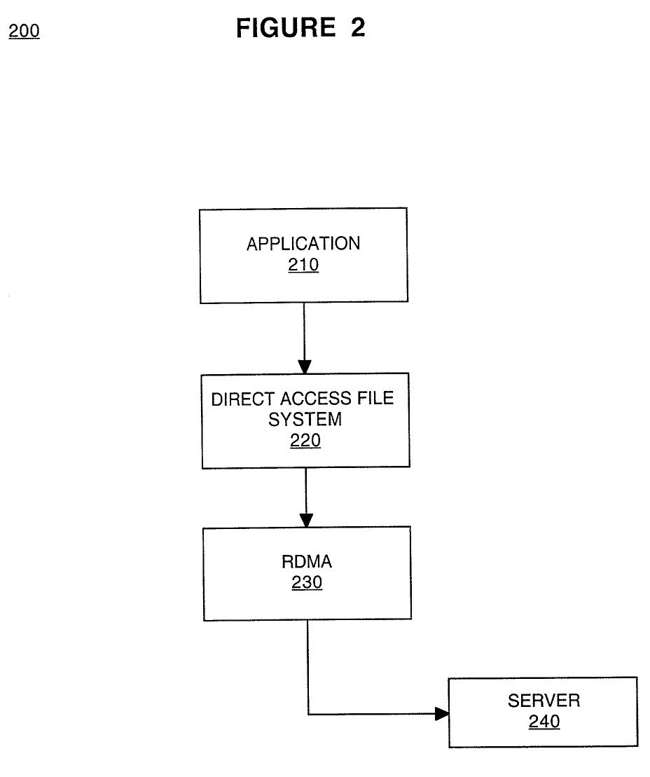

FIG. 3 is a block diagram of an exemplary computer system upon which embodiments of the present invention may be utilized.

FIG. 4 is a block diagram of a Network File System implementation using Remote Direct Memory Access in accordance with one embodiment of the present invention.

FIG. 5 illustrates in greater detail the RDMA interconnect used in accordance with embodiments of the present invention.

FIG. 6 is a flowchart of a method for performing a file request utilizing Remote Direct Memory Access in accordance with embodiments of the present invention.

FIG. 7 is a flowchart of an exemplary RPC data transfer using the RDMA Read only protocol in accordance with embodiments of the present invention.

FIG. 8 is a flowchart of an exemplary RPC data transfer using the RDMA Write only protocol in accordance with embodiments of the present invention.

FIG. 9 is a flowchart of an exemplary RPC data transfer using the RDMA Read/Write protocol in accordance with embodiments of the present invention.

### DETAILED DESCRIPTION OF THE PREFERRED EMBODIMENT

Reference will now be made in detail to the preferred embodiments of the present invention, examples of which are illustrated in the accompanying drawings. While the present invention will be described in conjunction with the preferred embodiments, it will be understood that they are not intended to limit the present invention to these embodiments. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “searching,” “reading,” “writing,” “opening,” “closing,” “generating,” “formatting,” “initiating,” “exchanging” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

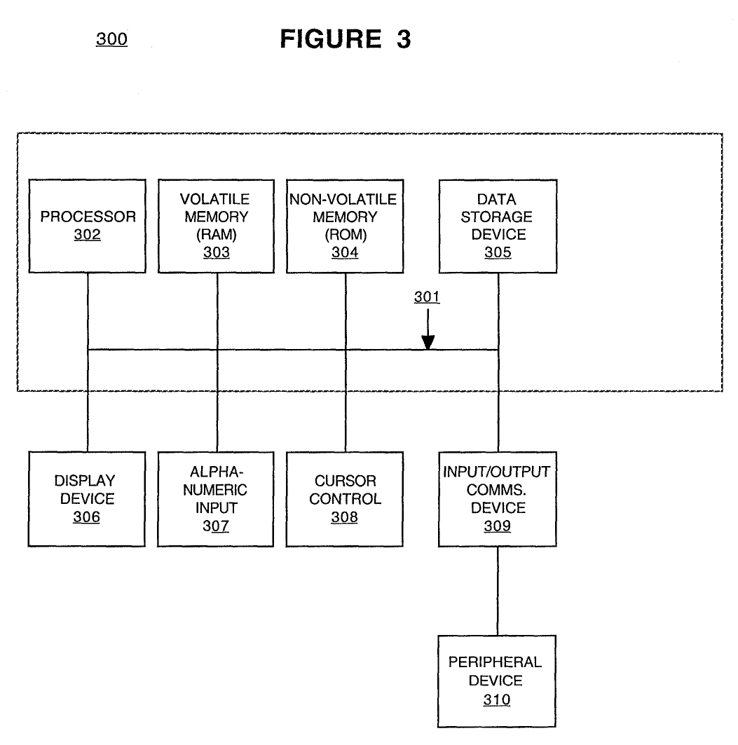

With reference to FIG. 3, portions of the present invention are comprised of computer-readable and computer-executable instructions that reside, for example, in computer system 300 which is used as a part of a general purpose computer network (not shown). It is appreciated that computer system 300 of FIG. 3 is exemplary only and that the present invention can operate within a number of different computer systems including general-purpose computer systems, embedded computer systems, laptop computer systems, hand-held computer systems, and stand-alone computer systems.

In the present embodiment, computer system 300 includes an address/data bus 301 for conveying digital information between the various components, a central processor unit (CPU) 302 for processing the digital information and instructions, a volatile main memory 303 comprised of volatile random access memory (RAM) for storing the digital information and instructions, and a non-volatile read only memory (ROM) 304 for storing information and instructions of a more permanent nature. In addition, computer system 300 may also include a data storage device 305 (e.g., a magnetic, optical, floppy, or tape drive or the like) for storing vast amounts of data. It should be noted that the software program for exchanging data utilizing Remote Direct Memory Access of the present invention can be stored either in volatile memory 303, data storage device 305, or in an external storage device (not shown).

Devices which are optionally coupled to computer system 300 include a display device 306 for displaying information to a computer user, an alpha-numeric input device 307 (e.g., a keyboard), and a cursor control device 308 (e.g., mouse, trackball, light pen, etc.) for inputting data, selections, updates, etc. Computer system 300 can also include a mechanism for emitting an audible signal (not shown).

Returning still to FIG. 3, optional display device 306 of FIG. 3 may be a liquid crystal device, cathode ray tube, or other display device suitable for creating graphic images and alpha-numeric characters recognizable to a user. Optional cursor control device 308 allows the computer user to dynamically signal the two dimensional movement of a visible symbol (cursor) on a display screen of display device 306. Many implementations of cursor control device 308 are known in the art including a trackball, mouse, touch pad, joystick, or special keys on alpha-numeric input 307 capable of signaling movement of a given direction or manner displacement. Alternatively, it will be appreciated that a cursor can be directed an/or activated via input from alpha-numeric input 307 using special keys and key sequence commands. Alternatively, the cursor may be directed and/or activated via input from a number of specially adapted cursor directing devices.

Furthermore, computer system 300 can include an input/output (I/O) signal unit (e.g., interface) 309 for interfacing with a peripheral device 310 (e.g., a computer network, modem, mass storage device, etc.). Accordingly, computer system 300 may be coupled in a network, such as a client/server environment, whereby a number of clients (e.g., personal computers, workstations, portable computers, minicomputers, terminals, etc.) are used to run processes for performing desired tasks (e.g., formatting, generating, exchanging, etc.). In particular, computer system 300 can be coupled in a system for exchanging data utilizing Remote Direct Memory Access.

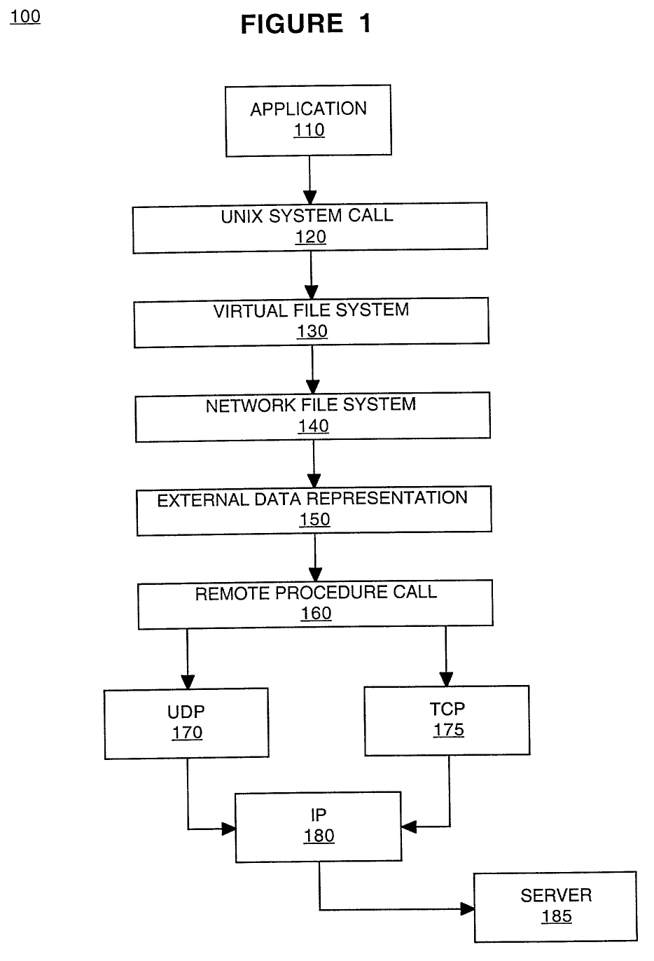

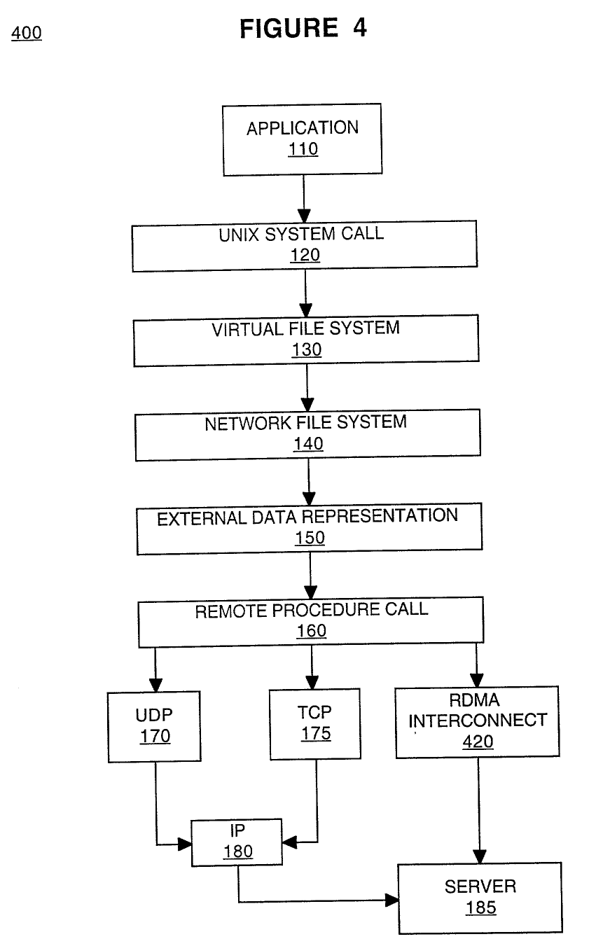

FIG. 4 is a block diagram of an exemplary file access system utilizing the Network File System protocol over Remote Direct Memory Access in accordance with one embodiment of the present invention. As shown in FIG. 4, system 400 builds upon the NFS implementation shown in FIG. 1 by adding Remote Direct Memory Access interconnect 420 which bypasses the UDP 170 and TCP 175 transport layers. In so doing, the present invention provides a high speed file access connection to server 185 which will require no modifications to existing APIs and protocols. In one embodiment, the standard Unix system call layer 120 remains unchanged. Additionally, in one embodiment no changes are required for the existing Network File System protocol or RPC transport protocols. In another embodiment, no changes to applications running on NFS or existing NFS administration are required.

As previously mentioned, in other implementations, the separation of the XDR and RPC layers is not as well defined and calls are passed between the XDR/RPC layer and the NFS layer. For example,NFS layer 140 makes a call to XDR/RPC layer to invoke a Remote Procedure Call. The RPC implementation calls into the XDR implementation in order to encode the arguments and responses for the Remote Procedure Call. XDR implementation calls into NFS layer 140 for information required to encode the specific NFS call being performed. NFS layer 140 returns a response to the XDR call which in turn returns a response to the RPC implementation. RDMA interconnect 420 is then used to perform the Remote Procedure Call.

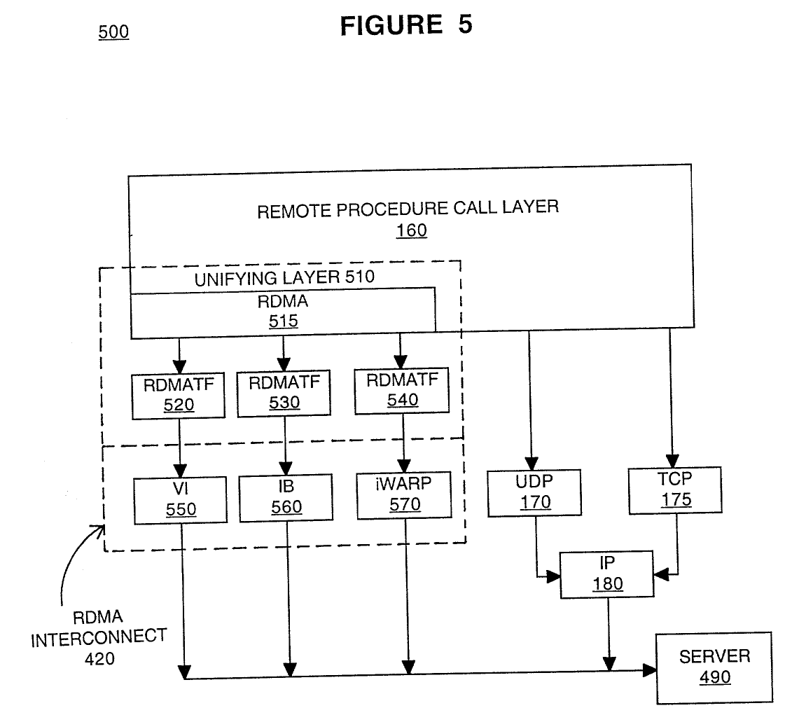

FIG. 5 illustrates in greater detail the RDMA interconnect used in accordance with embodiments of the present invention. As shown in FIG. 5, interconnects between the previously existing transport protocols (e.g., UDP 170 and TCP 175) remain.

RDMA interconnect 420 is comprised of a unifying layer 510 which communicates with various RDMA implementations. Unifying layer 510 has a generic top-level RDMA interface 515 which converts the RPC semantics and syntax to RDMA semantics and insulates RPC layer 160 from the underlying RDMA interconnects. Additionally, unifying layer 510 has a plurality of Remote Direct Memory Access Transport Framework components (e.g., RDMATF 520, 530, and 540). Each RDMATF component is a low-level interface between the converted RDMA semantics and the specific underlying interconnect drivers (e.g., VI 550, IB 560, and iWARP 570).

VI 550 is the Virtual Interface Architecture which is a RDMA Application Programming Interface (API) which is used by some RDMA implementations. IB 560 and iWARP 570 are future RDMA transport level protocol implementations.

Unifying layer 510 allows high speed RPC data transfer to applications while utilizing multiple underlying high speed RDMA based interconnects. It normalizes access to different RDMA based interconnects so that applications need not be aware of the underlying connections. This allows RDMA interconnects to be implemented without changing applications currently running on NFS and without requiring significant changes in NFS administration. It allows NFS to create client and server handles over RDMA and to transfer RPC messages using the RDMA Read and RDMA Write operations. Furthermore, as new RDMA implementations become available, they can easily be integrated by creating a RDMATF interface for that particular implementation.

There are two types of data transfer facilities provided by RDMA-based interconnects: the traditional Send/Receive model and the Remote Direct Memory Access (RDMA) model. The Send/Receive model follows a well understood model of transferring data between two endpoints. In this model, the local node specifies the location of the data. The sender specifies the memory locations of the data to be sent. The receiver specifies the memory locations where the data will be placed. The nodes at both ends of the transfer need to be notified of request completion to stay synchronized. In the RDMA model, the initiator of the data transfer specifies both the source buffer and the destination buffer of the data transfer.

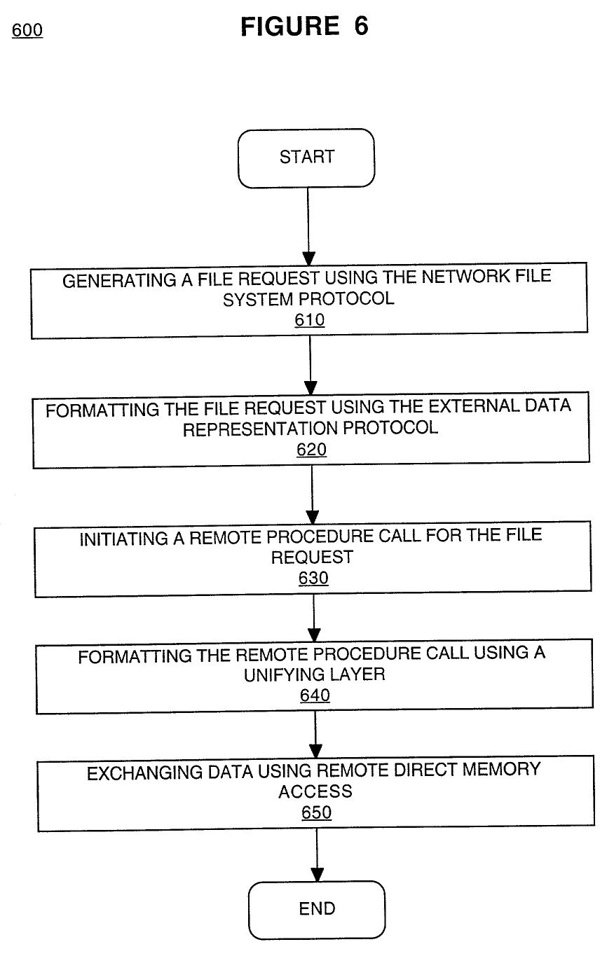

FIG. 6 is a flow chart of a method for performing file requests utilizing Remote Direct Memory Access in accordance with embodiments of the present invention. In step 610 of FIG. 6, the Network File System, in response to a system call, generates a file request. The file request can be for any number of file operations such as searching a directory, reading a set of directory entries, manipulating links and directories, accessing file attributes, and reading and writing files.

In step 620 of FIG. 6, the file request is formatted using the External Data Representation protocol. The External Data Representation protocol is used to unify differences in data representation encountered in heterogeneous networks.

In step 630 of FIG. 6, a Remote Procedure Call is initiated for the file request. The Remote Procedure Call provides a mechanism for the calling host to make a procedure call that appears to be part of the local process, but is really executed on another machine. The RPC bundles the arguments passed to it, creates a session with the appropriate server, and sending a datagram to a process on the server that can execute the RPC.

In step 640 of FIG. 6, the Remote Procedure Call is formatted by unifying layer 510 of FIG. 5. Unifying layer 510 converts the syntax of the remote procedure call into a RDMA syntax. The message is then passed to a Remote Direct Memory Access Transport Framework which communicates the procedure call with a specific RDMA implementation.

In step 650 of FIG. 6, data is exchanged using Remote Direct Memory Access. Following a RDMA Read, RDMA Write, or RDMA Read/Write protocol, data is exchanged between the calling host and the server to accomplish the file request.

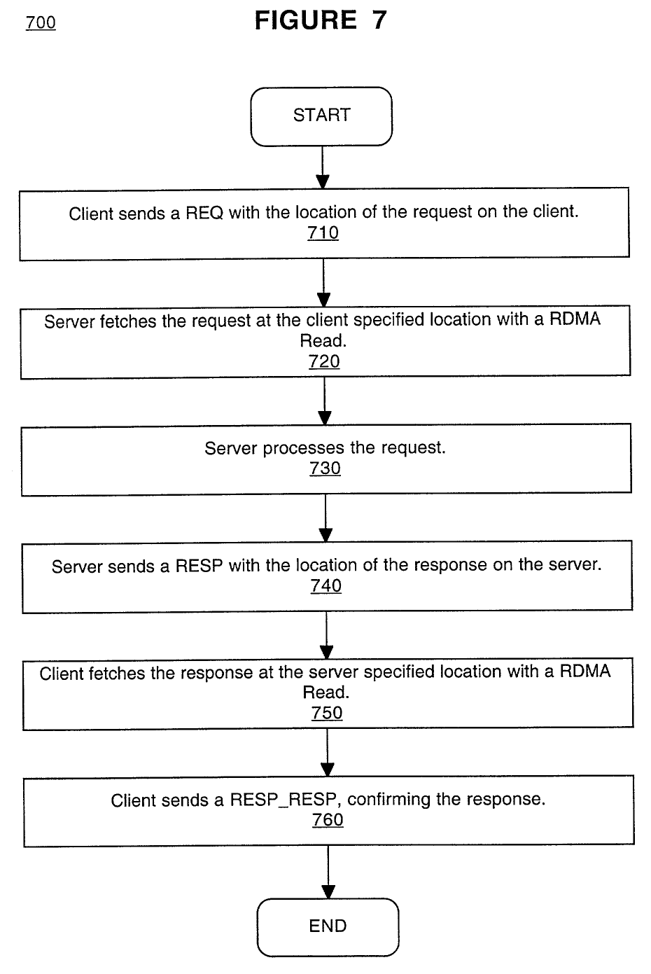

FIG. 7 is a computer implemented flowchart of an exemplary RPC data transfer using the RDMA Read only protocol in accordance with embodiments of the present invention. In step 710 a client sends a REQ message with the location of the request on the client. The server is notified of the request via a message queue. The location of the memory buffers on the client holding the request are sent to the server as well to enable the server to directly access the information and bypass the CPU on the client.

In step 720 of FIG. 7, the server fetches the request at the client specified location with a RDMA Read. The server utilizes the established RDMA interconnect to directly access and read the memory buffers on the client machine holding the request. The request is written directly into memory buffers on the server.

In step 730 of FIG. 7, the server reads and processes the request. In one instance, the request may be a file request such opening, reading, writing, or closing a file. In another instance, the request may be for a invoking a routine upon the server.

In step 740 of FIG. 7, the server sends a RESP with the location of the response on the server. The client receives the RESP via a message queue. The location of the memory buffers on the server holding the result are sent to the client.

In step 750 of FIG. 7, the client fetches the response at the server specified location with a RDMA Read. The client now utilizes the established RDMA interconnect to directly access and read the memory buffers on the server. The data is transferred directly from the server's memory buffers to the memory buffers of the client.

In step 760 of FIG. 7, the client sends a RESP_RESP to the server confirming the response. This signals to the server that the RDMA read has been completed.

For the RDMA Read operations, the client specifies the source of the data transfer at the remote end, and the destination of the data transfer within a locally registered region. In the case of VI, the source of an RDMA Read operation must be a single, virtually contiguous memory region, while the destination of the transfer can be specified as a scatter list of local buffers. Note that for most RDMA interconnects, RDMA Write is a required feature while RDMA Read is optional.

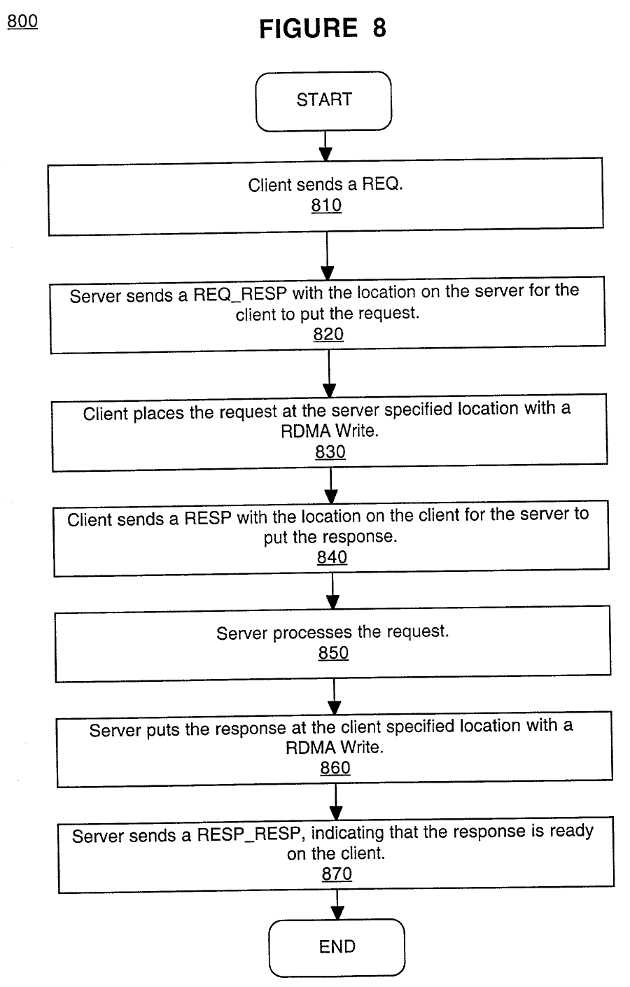

FIG. 8 is a computer implemented flowchart of an exemplary RPC data transfer using the RDMA Write only protocol in accordance with embodiments of the present invention. In step 810, the client sends a REQ to the server. This notification is sent via the message queue.

In step 820 of FIG. 8, the server sends a REQ_RESP with the location on the server for the client to put the request. This response, again sent by message queue, tells the client the location of the memory buffers on the server to which the request should be written.

In step 830 of FIG. 8, the client places the request at the server specified location with a RDMA Write. Using the established RDMA interconnect, the client writes the request directly into the memory buffer location specified by the server in step 820.

In step 840 of FIG. 8, the client sends a RESP with the location on the client for the server to put the response. Using the message queue, the client sends the location of the memory buffers to which the server will send the response.

In step 850 of FIG. 8, the server processes the request. In one instance, the request may be a file request such opening, reading, writing, or closing a file. In another instance, the request may be for a invoking a routine upon the server.

In step 860 of FIG. 8, the server puts the response at the client specified location with a RDMA Write. Again using the RDMA interconnect, the response is directly transferred from the server's memory buffers into the client memory buffers specified in step 840.

In step 870 of FIG. 8, the server sends a RESP_RESP indicating that the response is ready on the client. This indicates to the client that the response has been returned and the client can continue with the calling routine.

For the RDMA Write only operations, the client specifies the source of the data transfer in one of its local registered memory regions, and the destination of the data transfer within a remote memory region that has been registered with the remote NIC. For example, in the case of VI, the source of an RDMA Write can be specified as a gather list of buffers, while the destination must be a single, virtually contiguous region.

The present invention proposes three RDMA-based protocols for RPC data transfer. The first involves the above mentioned RDMA Write operations, the second involves the above mentioned RDMA Read operations, and the third uses combination of RDMA Read and RDMA Write operations.

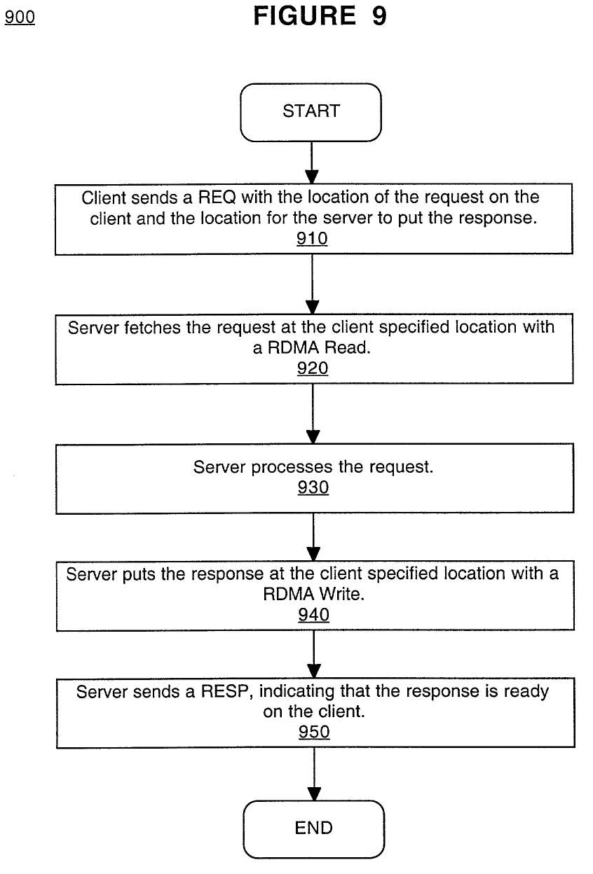

FIG. 9 is a computer implemented flowchart of an exemplary RPC data transfer using the RDMA Read/Write protocol in accordance with embodiments of the present invention. In step 910 of FIG. 9 the client sends a REQ with the location of the request on the client and the location for the server to put the response. This message is sent via the message queue to the server and contains the location of the request and the location where the response will be sent.

In step 920 of FIG. 9, the server fetches the request at the client specified location with a RDMA Read. The server utilizes the established RDMA interconnect to access the memory location and transfers the data in that memory buffer directly to a memory buffer on the server.

In step 930 of FIG. 9, the server processes the request.

In step 940 of FIG. 9, the server puts the response at the client specified location with a RDMA Write. Again using the established RDMA interconnect, the server performs a RDMA Write and the data in the server's memory buffers is transferred directly into the client memory buffers specified in step 910.

In step 950 of FIG. 9, the server sends a RESP indicating that the response is ready on the client. This informs the client that the response has been returned and allows the client to continue with calling routine.

In each of the above three protocols, a Send message follows the very last RDMA operation. This is because software notifications are necessary to synchronize the client and the server. The protocols described above can be further simplified by taking advantage of hardware features. For example, the Immediate Data feature of VI (only available for VI RDMA Writes) can save two messages (RESP and RESP_RESP) for the RDMA Write only protocol, provided that the client address (c_addr) which was originally sent with the RESP message is now sent with the REQ message.

The preferred embodiment of the present invention, a system for exchanging data utilizing remote direct memory access, is thus described. While the present invention has been described in particular embodiments, it should be appreciated that the present invention should not be construed as limited by such embodiments, but rather construed according to the following claims.

What is claimed is:

1. A system for exchanging data utilizing Remote Direct Memory Access comprising:
a Network File System component for generating a file request in response to a system call;
an External Data Representation component for describing the format of said file request;
a Remote Procedure Call component for initiating said file request with a remotely located computer system; and
a unifying layer for communicating said Remote Procedure Call with a plurality of transport layer Remote Direct Memory Access implementations used to exchange data with said remotely located computer system.

2. The system for exchanging data as recited in claim 1, wherein one of said plurality of Remote Direct Memory Access implementations is the Virtual Interface Architecture.

3. The system for exchanging data as recited in claim 2, wherein said unifying layer comprises:
a first component for converting said Remote Procedure Call to a Remote Direct Memory Access formatted message; and
a second component for communicating said Remote Direct Memory Access formatted message to a particular-transport layer Remote Direct Memory Access implementation.

4. The system for exchanging data as recited in claim 3, further comprising a plurality of said second components for communicating said Remote Direct Memory Access formatted message to various transport layer Remote Direct Memory Access implementations.

5. The system for exchanging data as recited in claim 4, wherein the Remote Direct Memory Access protocol is the default transport layer protocol for communicating said Remote Procedure Call.

6. A method for communicating data using Remote Direct Memory Access comprising:
generating a file request u sing the Network File System protocol;
formatting said file request using the External Data Representation protocol;
initiating a Remote Procedure Call for said file request;
formatting said Remote Procedure Call using a unifying layer for communicating with a plurality of transport layer Remote Direct Memory Access implementations; and
exchanging data using one of said Remote Direct Memory Access implementations wherein said file request is performed.

7. The method for communicating data using Remote Direct Memory Access as recited in claim 6, wherein one of said plurality of Remote Direct Memory Access implementations is the Virtual Interface Architecture.

8. The method for communicating data using Remote Direct Memory Access as recited in claim 7, wherein said formatting said of Remote Procedure Call comprises:
converting the format of said Remote Procedure Call to a Remote Direct Memory Access formatted message; and
utilizing an Application Programming Interface to communicate said Remote Direct Memory Access formatted message to a particular transport layer Remote Direct Memory Access implementation.

9. The method for communicating data using Remote Direct Memory Access as recited in claim 8, wherein a plurality of said Application Programming Interfaces communicate said Remote Direct Memory Access formatted message to said plurality of transport layer Remote Direct Memory Access implementations.

10. The method for communicating data using Remote Direct Memory Access as recited in claim 9, wherein said exchanging data comprises using the Remote Direct Memory Access protocol as the default transport layer protocol for communicating said Remote Procedure Call.

11. A computer system comprising:
a bus;
a memory unit coupled to said bus; and
a processor coupled to said bus, said processor for executing a method for communicating data using Remote Direct Memory Access comprising:
generating a file request using the Network File System protocol;
formatting said file request using the External Data Representation protocol;
initiating a Remote Procedure Call for said file request;
formatting said Remote Procedure Call using a unifying layer for communicating with a plurality of transport layer Remote Direct Memory Access implementations; and
exchanging data using one of said Remote Direct Memory Access implementations wherein said file request is performed.

12. The computer system as recited in claim 11, wherein one of said plurality of Remote Direct Memory Access implementations is the Virtual Interface Architecture.

13. The computer system as recited in claim 12, wherein said formatting said of Remote Procedure Call comprises:
converting the format of said Remote Procedure Call to a Remote Direct Memory Access formatted message; and
utilizing an Application Programming Interface to communicate said Remote Direct Memory Access formatted message to a particular transport layer Remote Direct Memory Access implementation.

14. The computer system as recited in claim 13, wherein a plurality of said Application Programming Interfaces communicate said Remote Direct Memory Access formatted message to said plurality of transport layer Remote Direct Memory Access implementations.

15. The computer system as recited in claim 14, wherein said exchanging data comprises using the Remote Direct Memory Access protocol as the default transport layer protocol for communicating said Remote Procedure Call.

16. A computer-usable medium having computer-readable program code embodied therein for causing a computer system to perform a method for communicating data using Remote Direct Memory Access comprising:
generating a file request using the Network File System protocol;
formatting said file request using the External Data Representation protocol;
initiating a Remote Procedure Call for said file request;
formatting said Remote Procedure Call using a unifying layer for communicating with a plurality of transport layer Remote Direct Memory Access implementations; and
exchanging data using one of said Remote Direct Memory Access implementations wherein said file request is performed.

17. The computer-usable medium as recited in claim 16, wherein one of said plurality of Remote Direct Memory Access implementations is the Virtual Interface Architecture.

18. The computer-usable medium as recited in claim 17, wherein said formatting said of Remote Procedure Call comprises:
converting the format of said Remote Procedure Call to a Remote Direct Memory Access formatted message; and
utilizing an Application Programming Interface to communicate said Remote Direct Memory Access formatted message to a particular transport layer Remote Direct Memory Access implementation.

19. The computer-usable medium as recited in claim 18, wherein a plurality of said Application Programming Interfaces communicate said Remote Direct Memory Access formatted message to said plurality of transport layer Remote Direct Memory Access implementations.

20. The computer-usable medium as recited in claim 19, wherein said exchanging data comprises using the Remote Direct Memory Access protocol as the default transport layer protocol for communicating said Remote Procedure Call.
